(19) United States
(12) Patent Application Publication
(10) Pub. No.: US 2004/0090464 A1
(43) Pub. Date: May 13, 2004

(54) Method for automatically determining equipment control code sets from a database and presenting information to a user interface

(76) Inventors: Francis David Shake, Phoenix, AZ (US); Jeffrey Chircus, Paradise Valley, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/701,138

(22) Filed: Nov. 3, 2003

Related U.S. Application Data
(60) Provisional application No. 60/422,607, filed on Nov. 1, 2002.
(60) Provisional application No. 60/422,641, filed on Nov. 1, 2002.
(60) Provisional application No. 60/422,606, filed on Nov. 1, 2002.
(60) Provisional application No. 60/429,978, filed on Dec. 2, 2002.

(51) Int. Cl. G09G 5/00

(52) U.S. Cl. 345/773

(57) ABSTRACT

A system and method for automatically determining equipment control sets and presenting the information to a database for generation of a user interface is disclosed. A control network adapter (“CNA”) is designed to automatically determine the control code sets for almost any controllable product by executing an Automatic Configuration Routine (“ACR”) and then presents this information to a user interface, for example to a graphic user interface or to a network, for example, a transmission control protocol/Internet protocol (TCP/IP) network through the use of an automatically generated web page. The CNA has the ability to automatically determine what kind of device it is controlling and what are the appropriate control codes to effectuate control of the device, thus eliminating the need for cumbersome, expensive manual programming of the controller with device-specific codes.

### CLAIM TO DOMESTIC PRIORITY

This application claims the benefit of priority to U.S. Provisional application Ser. No. 60/422,607 entitled “Method for Automatically Determining Equipment Control Code Sets from a Database with No User Interaction or User Programming” filed Nov. 1, 2002, by Francis David Shake; U.S. Provisional application Ser. No. 60/422,641 entitled “Ethernet Enabled Home and Building Automation Control System with Integrated Feedback” filed Nov. 1, 2002, by Francis David Shake; U.S. Provisional application Ser. No. 60/422,606 entitled “Method for Automatically Calibrating a Power Current Sensor Circuit for a Given Piece of Equipment with No User Interaction or User Programming” filed Nov. 1, 2002, by Francis David Shake; and U.S. Provisional application Ser. No. 60/429,978 entitled “Method for Automatically Determining Equipment Control Code Sets from a Database and Presenting this Information to the TCP/IP Network Via Universal Plug and Play” filed Dec. 2, 2002, by Francis David Shake; and they are herein incorporated by reference in their entirety.

### FIELD OF THE INVENTION

This invention concerns generally a system and method for automatically determining control code sets for any controllable product, and more particularly, to a control system, such as a control network adapter, and method for automatically determining control code sets for any controllable product and presenting this information to an automatically generated user interface, for example to a graphic user interface (GUI) or to a network through an automatically generated web page.

### BACKGROUND OF THE INVENTION

Numerous pieces of electronic equipment and devices are user controlled products and commonly provide some type of user interface or control mechanism. These controllable products are found in a variety of environments including, but not limited to, automobiles, home, office, educational, research and non-profit institutions, manufacturing, and other industrial facilities, and government operations. Examples of controllable products with user interface and/or controllable functions include, but are not limited to, televisions, telephones, video conference equipment, printers, fax machines, video and audio players and recorders, appliances, security systems, heating, ventilation and air conditioning (HVAC) systems, thermostats, pool and spa controllers, sprinkler systems, lighting systems and any other type of network media server, user interface device, relay or contact activated equipment, infrared (IR) controlled equipment or input/output (I/O) equipment. Normally, each of these controllable products has an individual controlling means, such as a remote control, control panel or other user interface.

Current user interface and control systems for these devices commonly include user input and display functions or mechanisms. One example of such input and display mechanisms include light emitting displays such as LED/LCD elements. These input and display elements are usually small and compact in order to minimize the overall size of the device.

Attempts at enhancing and consolidating device user interface systems have included installation of screen-based interfaces within a device that provide a graphical user interface (GUI). However, such interfaces increase the size and cost of the devices. Other enhancements include using an external computer system to provide the graphical user interface; however, this also increases the cost and may not be feasible in every environment. For example, while graphical user interfaces are found in some high-end automobiles, they often do not consolidate all controllable products, nor can the user interface be configured to control devices not preconfigured with the automobile.

Further, even when control functions of have been consolidated from multiple remote controls or user interfaces, special software is usually required for different types of devices to link to the external computer system. Not only do the multiple software platforms that are required make an external computer system cumbersome, also increase the cost of development, programming, and maintenance of such systems.

Thus, a need exists for a system and method of providing automation for user controllable equipment in a variety of environments that allows users to control any or all of their controllable products with a single control device or mechanism without requiring the user to program the control mechanism for each product, while still providing for the ability to allow the user to easily interface with the control information.

### SUMMARY OF THE INVENTION

A solution for automatically configuring a control system to control numerous devices with a single controller with the capability of presenting the control information to a user interface is disclosed. In one embodiment, a method for controlling an electronic device using a data processing device is disclosed, comprising the steps of retrieving a control code from a database, wherein the control code corresponds to an electronic device; using the control code to configure a communication port, wherein the communication port is capable of sending a control signal to the electronic device; sending the control signal to the electronic device; detecting the presence or absence of a reaction feedback to the control signal; and retrieving a set of control codes from the database for the electronic device based on the presence of the reaction feedback.

In another embodiment, a system for controlling electronic devices, comprising a data processing device with a communication port is disclosed, wherein the data processing device is capable of retrieving a control code from a database, wherein the control code corresponds to an electronic device; using the control code to configure the communication port, wherein the communication port is capable of sending a control signal to the electronic device; sending the control signal to the electronic device; detecting the presence or absence of a reaction feedback to the control signal; and retrieving a set of control codes from the database for the electronic device based on the presence of the reaction feedback. The system may further comprise a database, wherein the database includes the control code corresponding to the electronic device.

In another embodiment, an electrical chip is disclosed comprising a data processing device, wherein the data processing device is electrically coupled to a communication port, wherein the communication port is capable of sending or receiving information from an exterior source; and a database containing a control code, wherein the control code corresponds to an electronic device. The electrical chip may further comprise a universal plug and play control or feedback sense circuitry.

In another embodiment, a computer-readable storage medium is disclosed, containing computer executable code for instructing a data processing device to perform the steps of: retrieving a control code from a database, wherein the control code corresponds to an electronic device; using the control code to configure the communication port, wherein the communication port is capable of sending a control signal to the electronic device; prompting the communication port to send the control signal to the electronic device; detecting the presence or absence of a reaction feedback to the control signal; and retrieving a set of control codes from the database for the electronic device based on the presence of the reaction feedback.

Other novel features and advantages of the present invention will be apparent from the detailed description and appended claims.

### BRIEF DESCRIPTION OF THE DRAWINGS

FIG. 1 illustrates a general overview of a system for executing an automatic configuration routine (“ACR”) for configuring a control network adapter for electronic devices;

FIG. 2 illustrates the general layout of a control network adapter that executes the automatic configuration routine according to one embodiment of the disclosure;

FIG. 3 provides a simplified diagram illustrating the functionality of a control network adapter, as it executes the automatic configuration routine with respect to a particular device;

FIG. 4 illustrates an example of one embodiment, according to the disclosure, of a system used to execute the automatic configuration routine, for example for an industrial application;

FIG. 5 illustrates another example of one embodiment, according to the disclosure, of a system used to execute the automatic configuration routine;

FIG. 6 is a flowchart illustrating a method, according to the disclosure, of executing the automatic configuration routine;

FIG. 7 is a flowchart illustrating an example of one embodiment of a method, according to the disclosure, of executing the automatic configuration routine;

FIG. 8 is a flowchart illustrating another example of one embodiment of a method, according to the disclosure, of executing the automatic configuration routine, namely with respect to infrared (IR) controllable products;

FIG. 9 is a flowchart illustrating a selection process for the embodiment depicted in FIG. 8.

FIG. 10 illustrates another example of one embodiment of a method according to the disclosure, namely the use of bi-directional communication;

FIG. 11 is a flowchart illustrating a calibration routine as applied to power current sensing (“PCS”) devices, where PCS is the detected feedback for the automatic configuration routine.

FIG. 12 is a further example of an automatic configuration routine according to one embodiment of the disclosure.

FIGS. 13-15 are illustrations of automatically generated web pages based on information presented to it following the execution of an automatic configuration routine, according to one embodiment of the disclosure.

### DETAILED DESCRIPTION OF VARIOUS EMBODIMENTS

The present invention discloses a control system, herein referred to as a control network adapter, for example, and method for automatically determining control code sets for any controllable device. A control network adapter (“CNA”) is designed to automatically determine the control code sets for almost any controllable product by executing an Automatic Configuration Routine (“ACR”) and then presents this information to a user interface, for example to a graphic user interface or to a network, for example, a transmission control protocol/Internet protocol (TCP/IP) network through the use of an automatically generated web page.

By way of example only, the CNA is UPnP enabled so that it automatically attaches itself to the network and presents information about the controllable product that is attached to it. By serving as a bridge between the Universal Plug and Play (UPnP) control network and the non-UPnP enabled controllable product or controllable device, the CNA provides the device with the benefits of the UPnP, including automatic device discovery, device control, and device event support.

By presenting the device's control parameters via an automatically generated web page, the device control resides on a TCP/IP network. Further the device control is capable of providing status to any other UPnP device as well as being automatically controlled by any UPnP control point.

The goal of the ACR is to automatically discover which controlled devices have been connected to the CNA and retrieve the control information about a device from a control code database. In order for a control network adapter to control an external device, the control network adapter's data processing device must use the appropriate control codes to communicate with that device. Previously, this required user programming of the control network adapter with the appropriate codes.

However, if a CNA's data processing device and the device are in a feedback loop, the data processing device may scroll through a database of available control codes. By looking for positive reaction feedback from the external device, the CNA has the ability to automatically determine when the CNA has found the appropriate control codes for the particular external device in the database. The CNA thus has the ability to automatically determine what kind of device it is controlling and what are the appropriate control codes to effectuate control of the device, thus eliminating the need for cumbersome, expensive manual programming of the controller with device-specific codes.

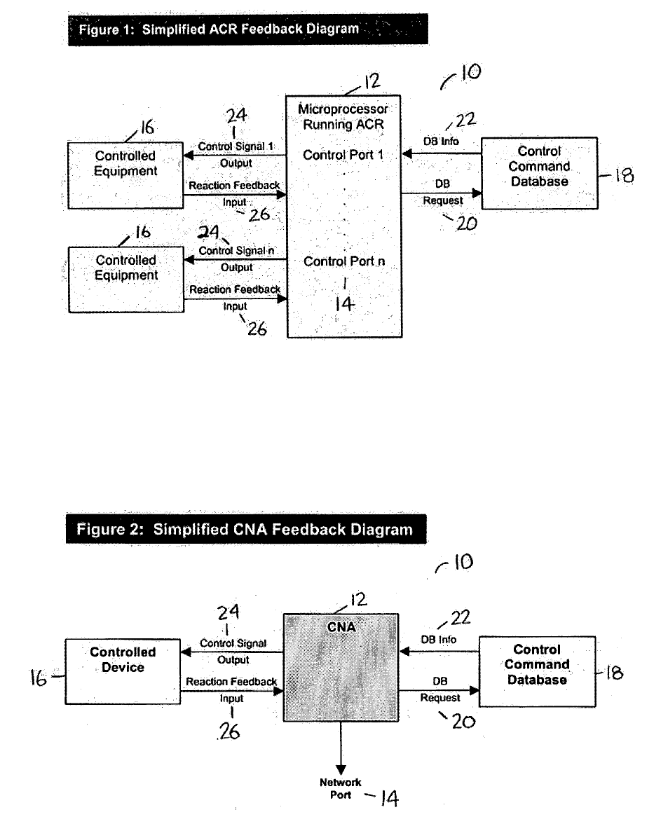

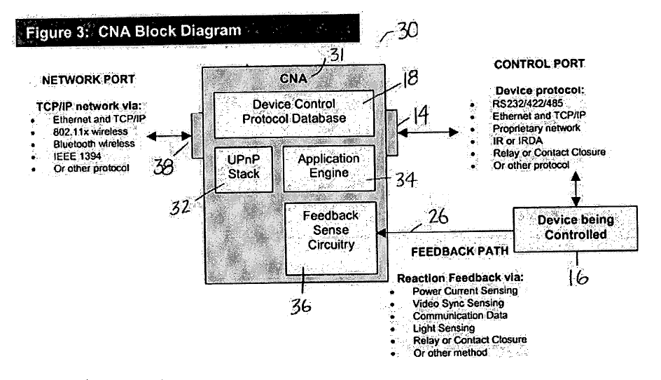

FIGS. 1 and 2 illustrate a general overview of the system and method used to execute the Automatic Configuration Routine (“ACR”), along with some key steps involving the inter-relationship between the elements of the system and the controlled device. FIG. 1 includes a Data Processing Device 12, as well as one or more Control Ports 14, a Control Command Database 18, and one or more controllable devices, Controlled Equipment 16.

The Data Processing Device 12 may consist of one or more of the following: a microprocessor, a microcontroller, a personal computer (“PC”), or any other device that can process information obtained from a database.

The Control Command Database 18 contains a series of control codes for a variety of types of controllable equipment and products. The Control Command Database 18 may reside in the same physical location as the Data Processing Device 12. For example, Control Command Database 18 and Data Processing Device 12 may be coupled on an electronic chip.

Further, Control Command Database 18 may be electrically coupled to Data Processing Device 12 in the Control Network Adapter (“CNA”) (as illustrated in FIG. 2) or Control Command Database 18 may be physically separate from, but in communication with, Data Processing Data Processing Device 12. Alternatively, Control Command Database 18 may reside in a location adjacent to or near Data Processing Device 12, or it may reside in a location farther away from the Data Processing Device 12.

The Data Processing Device 12 contains one or more Control Ports 14. Each of the Control Ports “1” through “n” (the “Control Ports 14”) is capable of sending or receiving information to and from Control Command Database 18 or Controlled Equipment 16, or both. In one embodiment of the Automatic Configuration Routine, there may be a single Port 14 which sends and receives signals from and to the Control Command Database 18 and each Controlled Equipment 16. For example, a single Control Port 14 could be used in the case of bi-directional RS232 communication.

In an alternate embodiment, there will be more than one Control Port 14. The number of Control Ports 14 may depend, in certain situations, on one or more of following: the type of Data Processing Device 12, the type of Control Command Database 18, the type(s) of Controlled Equipment 16, or the types of signals used for communications, among other potential factors.

Data Processing Device 12 retrieves information from Control Command Database 18 in order to configure the CNA, making it capable of controlling Controlled Equipment 16. To initiate the Automatic Configuration Routine (“ACR”) sequence, Data Processing Device 12 sends a Request 20 to the Control Command Database 18. The Request 20 is sent to obtain information from the Control Command Database 18.

The information includes a potential control code from the Control Command Database 18 that may or may not cause an identifying Reaction Feedback 26 from Controlled Equipment 16. If identifying Reaction Feedback occurs, the control code configures the CNA for the particular Controlled Equipment 16, making it capable of controlling Controlled Equipment 16.

Control codes in Control Command Database 18 are device communication protocols, for example, bi-directional including RS232, RS422, or RS485 (RS232, RS422, and RS485 refer to certain “recommended standards” for data communications established by the Electronics Industry Association) that are often used for audio/video equipment, lighting systems, heating ventilation and air conditioning systems (HVAC) and security systems. Control codes also include device communication protocols for networks, such as Ethernet, TCP/IP, or proprietary networks such as AMX, Crestron, ELAN, Lutron, X-10, CEBus or other proprietary networks. Control codes also include IR or IRDA that are often used in audio/video systems and lighting systems, as well as Relay or Contact Closure or Light Sensing that are used in all types of sensors, motorized drapes, screens and lifts. Finally, many other types of device communication protocols are also included, for example, control connections such Sony S-link, Kenwood, or Panasonic SRS.

The control codes, according to the disclosure, are referred to as Database Information 22 which correspond and translate to Control Signals 24, and are also herein referred to as “Device-Dependent Signals.”

Identifying Reaction Feedback includes, but is not limited to, Power Current Sensing (PCS), video sync sensing, communication data, light sensing, relay or contact closure, or any other type of Reaction Feedback 26 produced by Controlled Equipment 16 as a response. If an identifying Reaction Feedback 26 does not occur, for example, no Feedback Reaction 26 from Controlled Equipment 20 in response, a second Request 20 is sent, continuing the feedback loop.

Further, Control Command Database 18 is capable of associating all control command codes for a particular device. Thus, once an identifying Reaction Feedback is received by the CNA for a particular Controlled Equipment 16, the CNA is capable of retrieving all control codes for Controlled Equipment 16 based on the database association of the control code which elicited the identifying Reaction Feedback 26 with the remaining control codes for Controlled Equipment 16.

The Control Command Database 18 then sends the control code, referred to at this point in the feedback loop as Database Information 22 through its associated Control Port 14 to Data Processing Device 12. The Data Processing Device 12 then sends the control code received from Control Command Database 18, referred to at this point in the feedback loop as Control Signal 24, through the same or second Control Port 14, depending on the embodiment, to Controlled Equipment 16. Thus, Database Information 22 corresponds and translates into Control Signal 24 previously received from the Control Command Database 18. The type of signal sent in this step for the Control Signal 24 may be of any type(s) of Device-Dependent Signal described above.

After receiving Control Signal 24, the Controlled Equipment 16 either reacts to the Control Signal 24, that is then detected as identifying Reaction Feedback 26 by Control Port 14 associated with the Data Processing Device 12, or fails to react, and Control Port 14 detects no Reaction Feedback 26. Again, the identifying Reaction Feedback signals detected in this step for the Reaction Feedback 26 may be any of the identifying Reaction Feedback 26 responses illustrated above, or any other type(s) of Device-Dependent Signals, as described above.

The Data Processing Device 12 then responds to the presence or absence of identifying Reaction Feedback 26. For example, the Data Processing Device 12 uses identifying Reaction Feedback 26 in order to determine whether or not the first control code of Database Information 22 (e.g., an initial product code) is compatible with the particular Controlled Equipment 16 sending the Reaction Feedback 26. If Data Processing Device 12 determines that identifying Reaction Feedback 26 is present, then Data Processing Device 12 determines that the particular Controlled Equipment 16 is identified and requests the additional associated control codes for that particular Controlled Equipment 16 from Control Command Database 18, in order to effectuate control by the CNA of all functions of Controlled Equipment 16.

If Data Processing Device 12 fails to detect an identifying Reaction Feedback 26, Data Processing Device 12 correlates the absence of identifying Reaction Feedback 26 with incompatibility of the control code with the particular Controlled Equipment 16. Thus, Data Processing Device 12 sends a second Request 20 to retrieve a second, different, control code from Control Command Database 18. The CNA then repeats this feedback loop until one of the control codes in the Control Command Database 18, sent as Control Signal 24, elicits a detectable identifying Reaction Feedback 26, identifying the particular Controlled Equipment 16. The entire process described above, herein referred to as the Automatic Configuration Routine (“ACR”), is then repeated for each Controlled Equipment 16 until the CNA is configured to control each and every desired piece of Controlled Equipment 16.

FIG. 3 provides a general layout of one embodiment of Control System 30. Control System 30 is represented here as a Control Network Adapter (“CNA”) 31 that generates the Automatic Configuration Routine (“ACR”). As discussed above, in one embodiment, Control System 30 is Control Network Adaptor (“CNA”) 31, which determines the control code sets for various types of Controlled Equipment 16.

The Control Network Adaptor 31, according to one embodiment, consists of the following, among other potential devices: Control Command Database 18, Data Processing Device 12 (FIG. 1), Application Engine 34, Feedback Sensory Circuitry 36, one or more Control Ports 14, and a Network Port 38. The Application Engine 34 contains computer-readable object code which enables the Data Processing Device 12 to function and to direct the steps necessary for the ACR.

In this embodiment, Control Port 14 sends the control codes to the Controlled Equipment 16, both in sending the control codes during the ACR and following CNA 31 configuration to control all functions of Controlled Equipment. The Control Port 14 uses one or more protocols, such as RS232/422/485, Ethernet, TCP/IP, a proprietary network, infrared, IRDA, relay or contact closure, or one or more other protocols, as discussed in detail above. The Control Port 14 is used to send control signals the Controlled Equipment 16, effectuating control of the Controlled Equipment 16 by CNA 31

The Feedback Sense Circuitry 36 detects the presence or absence of identifying Reaction Feedback 26 from the Controlled Equipment 16. The identifying Reaction Feedback 26 detected by the Feedback Sense Circuitry 36 includes, but is not limited to power current sensing, video sync sensing, communication data, light sensing, relay or contact closure, or other type(s). The detection of the presence or absence of identifying Reaction Feedback 26 is then used by the Data Processing Device 12 in order to configure the CNA 31 with the additional information pertaining to the Controlled Equipment 16.

In an alternate embodiment of CNA 31, there is also a Network Port 38, which transfers control and other information pertaining to the Controlled Equipment 16. The Network Port 38 uses one or more protocols, such as Ethernet, TCP/IP, 802.11x wireless, Bluetooth wireless, IEEE 1394, or one or more other protocols, in transferring the control information. The information may be used to generate user-accessible configurations, user interfaces or display pages, or other useful information.

In another embodiment of CNA 31, Feedback Sense Circuitry 36 and the Control Ports 14 may comprise a single port; whereas, in other embodiments they may be separate ports. Similarly, the Network Port 14 may also exist, in combination with the Control Port and/or the Feedback Sense Circuitry 36, as a single port in one embodiment, for example, with RS232 or other bi-directional communication ports; alternatively, they may exist as separate ports. CNA 31 may also contain a Universal Plug and Play (“UPnP”) Stack 32 in certain embodiments. The UPnP stack helps to make the Control System 30 easier to use, through automatic attachment to a network.

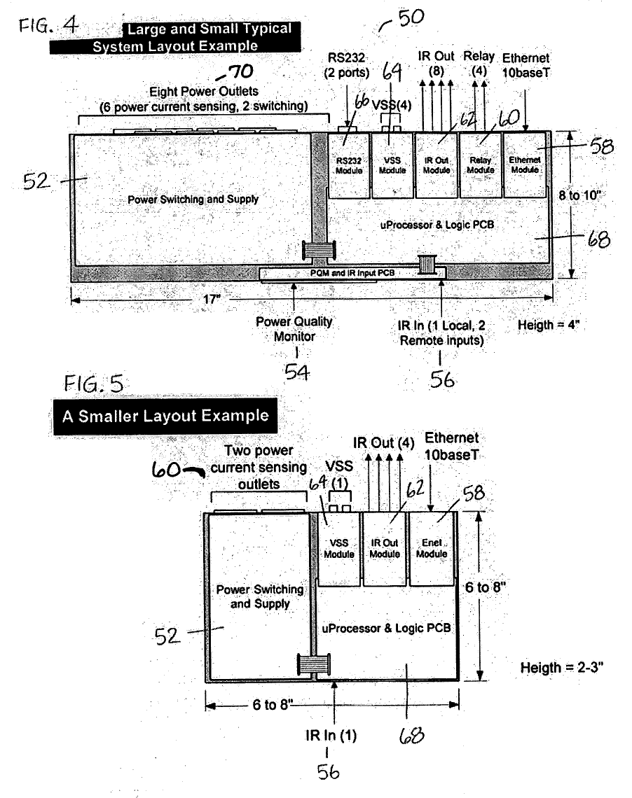

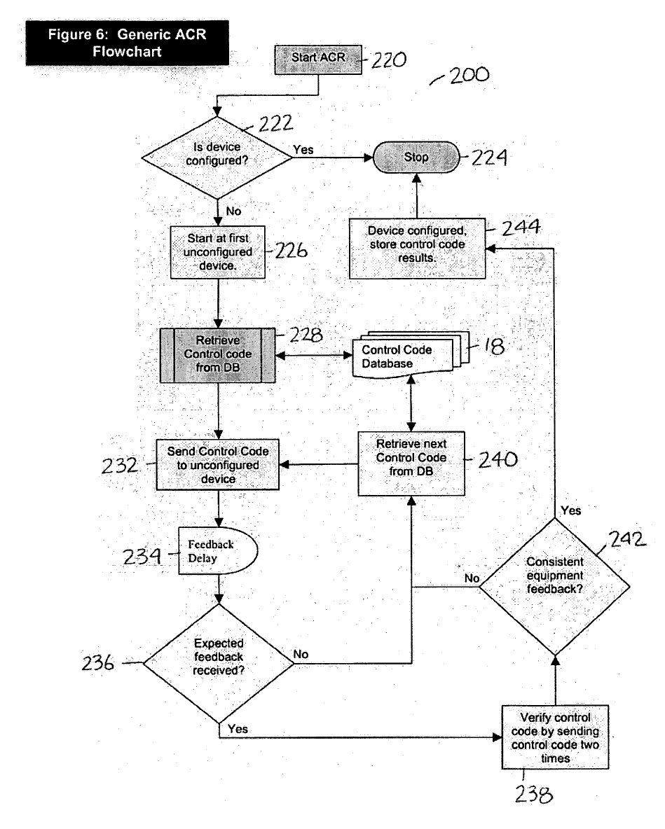

FIGS. 4 and 5 provide examples of alternate embodiments of the Control System, according to the disclosure. The Control Systems depicted illustrate differences that may be incorporated for use in large or small scale applications. FIG. 4 provides an example of a larger system layout, while FIG. 5 provides an example of a smaller system layout.

The example in FIG. 4, of an alternate layout for the system, Control System 50, may include, but is not limited to, the following devices: a Power Quality Monitor 54, an Infrared Input 56, an Ethernet Module 58, a Relay Module 60, an Infrared Out Module 62, a VSS Module 64, an RS232 Module 66, and a Data Processing Device, such as Microprocessor and Logic PCB 68, among other potential devices. Control System 50 may also include a Power Switching and Supply 52. The Power Switching and Supply 52 will consist of various Power Outlets 70.

In this embodiment, and by way of example only, Control System 50, the Power Switching and Supply 52 will contain eight Power Outlets 70. Six of the Power Outlets 70 will be power current sensing, while the other two Power Outlets 70 will be power switching. In this example, the RS232 Module 66 will have two ports, the VSS Module 64 will have four ports, the Infrared Out Module 62 will have eight ports, and the Relay Module 60 will have four ports. The Infrared Input 56 in this example will have one local input and two remote inputs.

The example in FIG. 5 is of a smaller layout for the system, Control System 60. Control System 60 may include, but is not limited to, the following: Power Switching and Supply 52, an Infrared Input 56, an Ethernet Module 58, an Infrared Output Module 62, a VSS Module 64, and a Microprocessor and Logic PCB 68, among other potential devices.

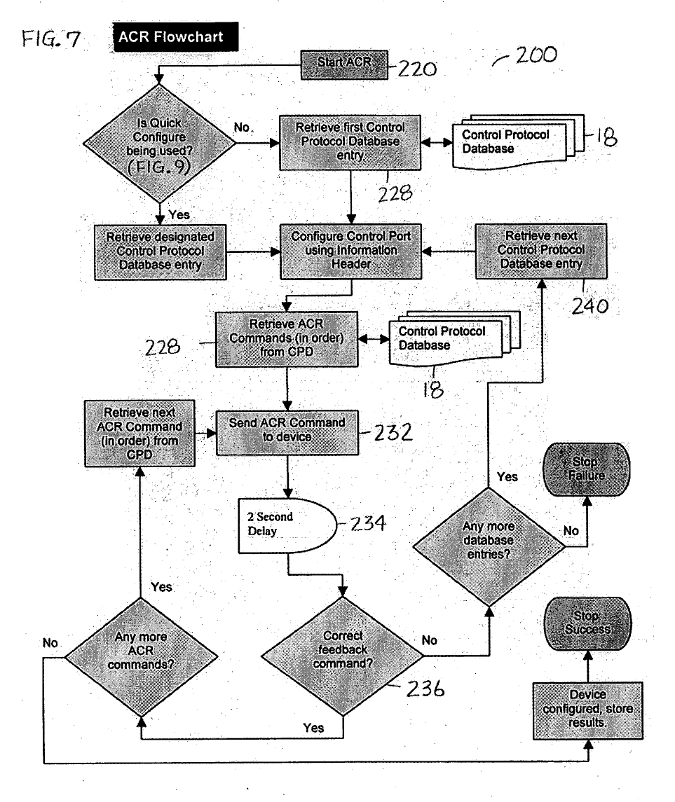

FIGS. 6 and 7 provide flowcharts illustrating the method according to one embodiment of the disclosure, herein referred to as Automatic Configuration Routine (“ACR”) 200, and is described in conjunction with FIGS. 1 and 2.

In FIGS. 6 and 7, ACR 200 begins with Step 220. In Step 222, the Data Processing Device 12 checks to determine whether or not the CNA is configured to control the particular Controlled Equipment 16. If the answer is “yes” (i.e., if the CNA has previously been configured for all desired Controlled Equipment 16), then the Routine stops, at Step 224. If the answer is “No” (i.e., if the CNA has not been configured for one or more Controlled Equipment 16), then ACR 200 proceeds to Step 226. In Step 226, the first unconfigured device is selected, to proceed with ACR 200.

In Step 228, Data Processing Device 12 obtains control command information from the Control Code Database 18. The request for information from the Data Processing Device 12, and the subsequent return of information from the Control Code Database 18, were previously referred to, in the discussion of FIGS. 1 and 2 above, as the Request 20 and Database Information 22, respectively.

During Step 228, a pointer is maintained in the Control Code Database 18 to ensure that identical commands are not repeated. The most common device control codes are used first, unless otherwise instructed by the user or by a configuration user interface. The Control Code Database 18 then, as part of Step 228, returns control code information to the Data Processing Device 12 based on where the pointer is within the Control Command Database 18. The Control Port 14 is configured based on the control code information received from the Control Command Database 18 in Step 228.

In Step 232, the Control Port 14 sends a signal, in the form of a control code, to the desired Controlled Equipment 16. The control code signal sent to the Controlled Equipment 16 is based upon the control code information obtained from the Control Command Database 18 in Step 228. Step 232 is the transmission of the first automatic configuration to the Controlled Equipment 16.

In Step 234, there is a delay, in which the Data Processing Device 12 waits to determine if it detects identifying Reaction Feedback 26 from Controlled Equipment 16. If identifying Reaction Feedback 26 is detected in Step 234, then ACR 200 proceeds to Step 238, described below. If no Reaction Feedback 26 is detected by the end of the delay/waiting period in Step 234, then ACR 200 proceeds to Step 240, described below.

When ACR 200 reaches Step 238 (i.e., when the identifying Reaction Feedback is detected in Step 234), then Control Port 14 re-sends the control code signal to the Controlled Equipment 16, a predetermined number of times, in order to verify that identifying Reaction Feedback 26 is present, and therefore that the control codes are indeed correct. ACR 200 then proceeds to Step 242, in which the Data Processing Device 12 again detects identifying Reaction Feedback 26 from the Controlled Equipment 16. Upon again detecting identifying Reaction Feedback 26, the Data Processing Device 12 then determines whether or not the identifying Reaction Feedback 26 is consistent.

Once identifying Reaction Feedback 26 detected in Step 242 is determined by the Data Processing Device 12 to be consistent for the control codes, then ACR 200 proceeds to Step 244. Alternatively, if there is no Reaction Feedback 26 in Step 242, then ACR 200 proceeds instead to Step 240.

If ACR 200 reaches Step 240 (i.e., if identifying Reaction Feedback is not detected in Step 234, or if the confirming Reaction Feedback is not detected in Step 242), then Control Network Adaptor 31 indexes the pointer in the Control Command Database 18 one position and repeats the process beginning at Step 228. For bi-directional communication such as RS232, the Control Network Adaptor 31 will wait a predetermined amount of time for an identifying Reaction Feedback 26.

For example, an identifying Reaction Feedback includes, but is not limited to, a return string from the device, or a return communication signal, in the example of a bi-directional communication, such as RS232. If no Reaction Feedback 26 is detected, or inconsistent Reaction Feedback 26 is detected, during the wait period, the Data Processing Device 12 continues to the next entry in the Control Command Database 18.

When ACR 200 reaches Step 244, CNA 31 is configured to control Controlled Equipment 16. In Step 244, the Data Processing Device 12 identifies the currently active entry in the Control Command Database 18, namely, the one the pointer is currently pointing to, as referenced in Steps 228 and 240 above, as belonging to that Control Port 14. The pointer in the Control Command Database 18 is then reset to the beginning location, and the process begins again, starting with Step 222, in order to configure a new piece of Controlled Equipment 16, and/or with a new Control Port 14, continuing from Control Port “1” through Control Port “n”, where there are “n” devices contained in the Control Port 14 apparatus, in the example where multiple ports are used. ACR 200 continues until it reaches Step 224, which terminates the process.

In the event that Step 224 is reached without the configuration of all of the pieces of the Controlled Equipment 16 (i.e., if the Control Command Database 18 entries are tested with no success for one or more pieces of the Controlled Equipment 16), then the user is taken through a simple-to-follow process of entering the codes directly into the Control Network Adaptor 31 for the unconfigured devices (e.g., in the case of an infrared-controlled device) or alternative modes of entry.

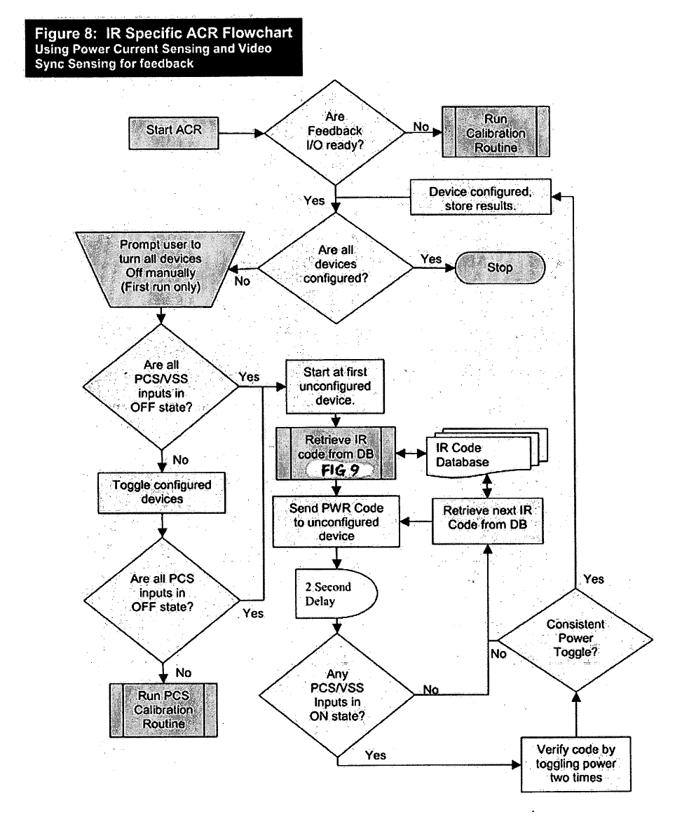

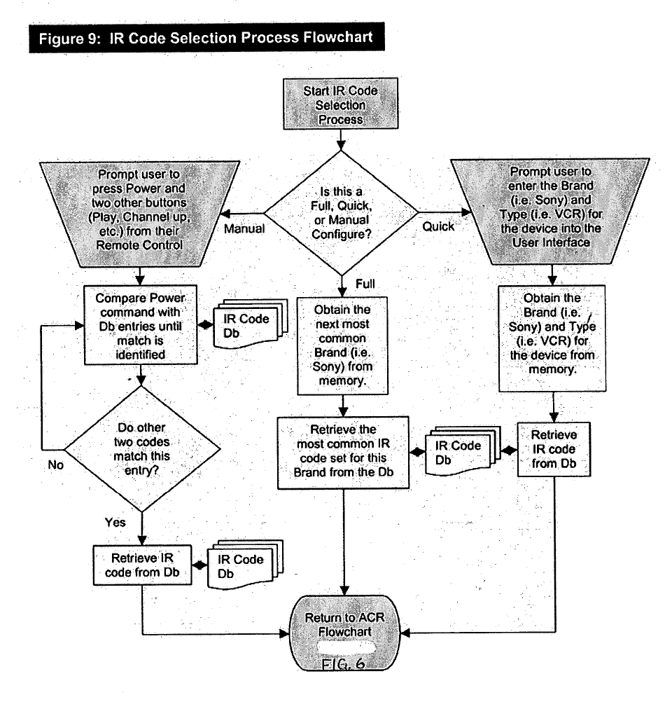

FIGS. 8 and 9 are flowcharts illustrating a specific example of the ACR process, with particular reference to an ACR process using an Infrared (IR) Code Database. FIG. 9 further illustrates an IR Code selection process, according to one embodiment of the disclosure. FIGS. 8 and 9 are flowcharts illustrating a specific example of the ACR process, with particular reference to an ACR process using an Infrared (IR) Code Database.

FIG. 8 illustrates an embodiment of the ACR Process, previously set forth in the discussion of FIGS. 6 and 7 above. In the FIG. 8 example, the control codes requested by the Data Processing Device 12 and returned by the Control Command Database 18 (referenced in Steps 228 and 240 in FIG. 6) are IR control codes. With reference to FIG. 1, the IR codes comprise Request 20 and Database Information 22. In FIG. 8, the control code signals sent by the Control Port 14 to the Controlled Equipment 16 (referenced in Steps 232 and 238 in FIG. 6) are IR Control Signals (referenced in Steps 236).

FIG. 8 also illustrates one example of a control code that may be used as the Control Signal in the ACR process, namely a power (e.g., power on, off or toggle) control code signal for Controlled Equipment 16. In this example, the user is asked to first manually turn off the Controlled Equipment 16. Following verification that all of the Controlled Equipment 16 are in the off state, the ACR Process begins, using infrared control codes and signals, as discussed above.

FIG. 9 further illustrates an IR Code selection process, according to one embodiment of the disclosure. The example in FIG. 9 illustrates a choice between three embodiments of the ACR process. In FIG. 9, the user first chooses whether to run one of three different ACR processes, namely the (i) “Full Configure,” (ii) “Quick Configure” or (iii) “Manual Configure” processes. If the user selects the Full Configure ACR process, then the Control Command Database 18 sends initial control codes to the Data Processing Device 12 using the same procedures as in FIGS. 6-8. Then, the ACR process continues, using the steps outlined in FIGS. 6-8.

The Quick Configure ACR process is the same as the Full ACR Process, except that the user enters the brand of the Controlled Equipment 16 into the user interface. Control Command Database 18 then begins the ACR process with control codes that are most likely to correspond with Controlled Equipment 16. If the user selects the Quick Configure ACR process, the brand name of Controlled Equipment 16 is used to determine the initial “most likely” control codes from the Control Command Database 18, which are then provided to the Data Processing Device 12. The “most likely” codes are the IR control codes most common to the user-specified brand. The ACR process then continues, according to the steps outlined in FIGS. 6-8.

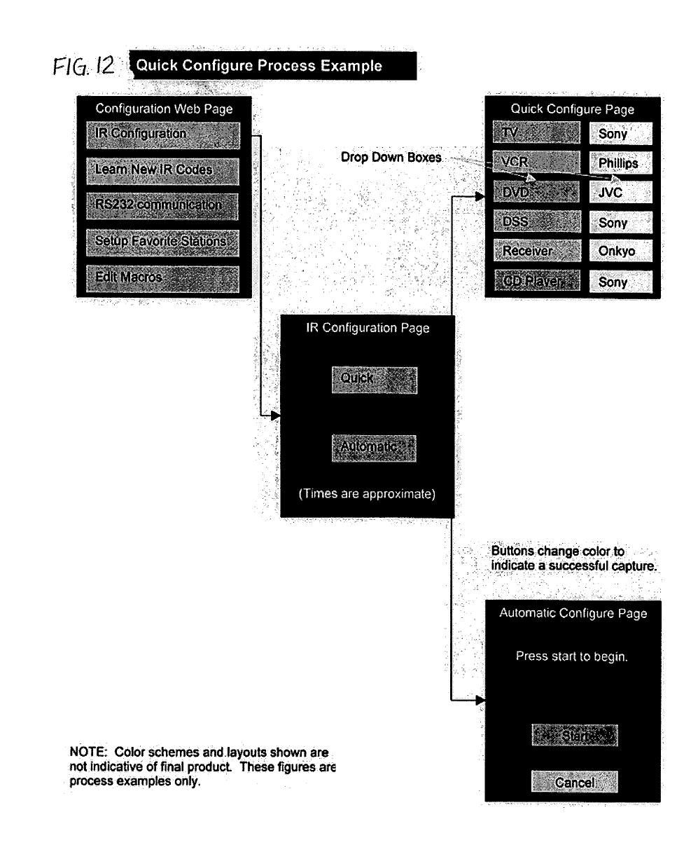

FIG. 12 is an example of a user interface for the Quick Configure automatic configuration routine according to one embodiment of the disclosure. The user interface can be any of a variety of user interfaces known in the art, including graphical user interface (GUI) or internet or web pages that are then presented to the TCP/IP network based on HTTP requests. The user interface is user-customizable, in that the look and feel of the “skin” can be modified according to user or manufacturer preference, or depending upon the specific mechanism used to display the user interface.

Returning to FIG. 9, the Manual Configure ACR process involves specific input of information from the user, with the inputted information determining the initial Database Information 22 in the ACR Process. If the user selects the Manual Configure ACR process, the manually-inputted information is used to obtain the initial control code from the Control Command Database 18, which is sent to the Data Processing Device 12. Then, the ACR Process then continues, using the steps outlined in FIGS. 6-8.

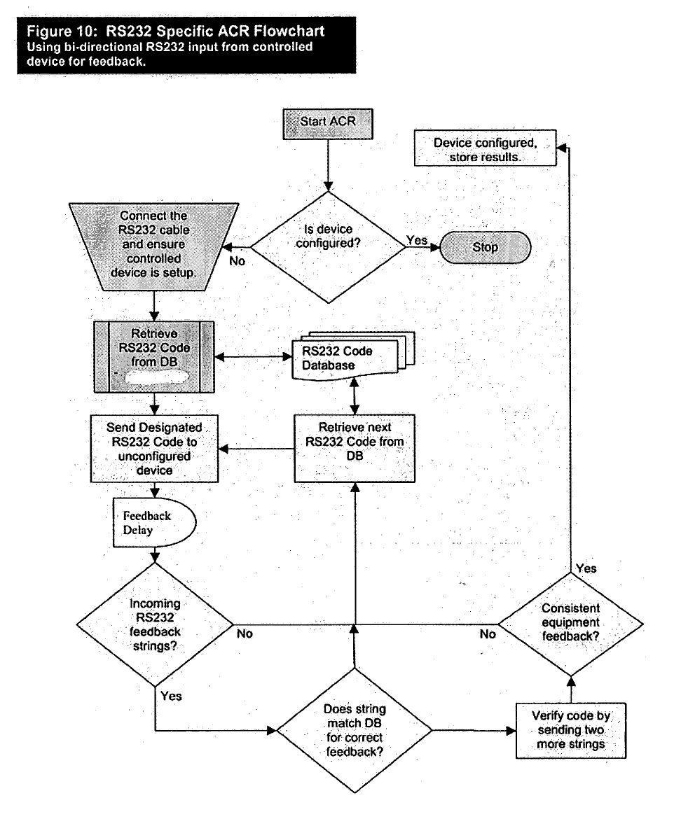

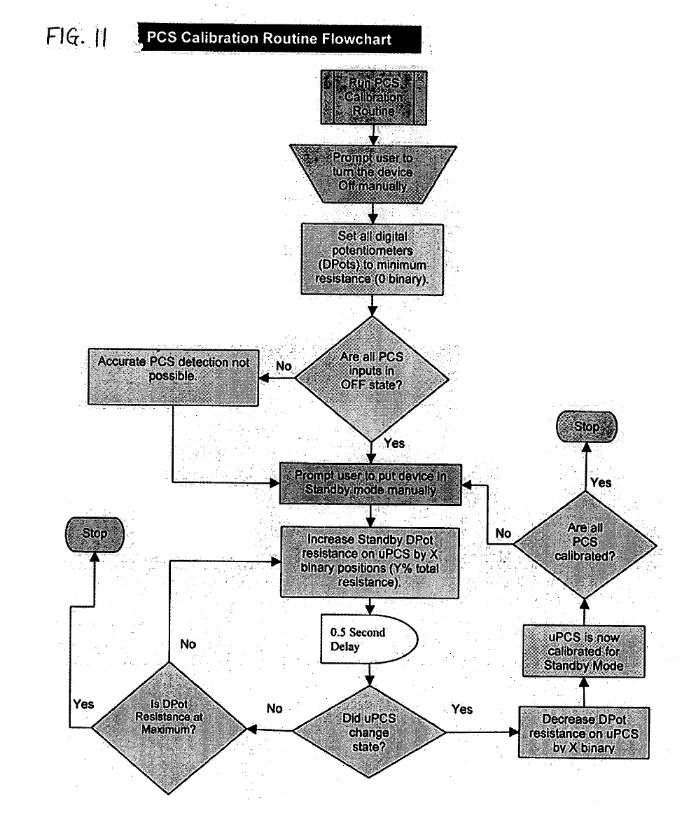

FIG. 10 is a flowchart illustrating another specific example of the ACR process described above, with particular reference to Controlled Equipment 16 with bi-directional RS232 communication. In FIG. 10, the control codes requested by the Data Processing Device 12 and returned by the Control Command Database 18 (referenced in Steps 228 and 240 in FIG. 6, and referenced as Database Information 22 in FIG. 1) are control codes for Controlled Equipment 16 with RS232 bi-directional communication Control Signals (defined previously in the discussion of FIGS. 1 and 2).

In FIG. 10, the Control Signal sent by Control Port 14 to the Controlled Equipment 16 (referenced in Steps 232 and 238 in FIG. 6) are RS232 bi-directional communication signals. Further, the identifying Reaction Feedback, in this example, can be a return signal sent by Controlled Equipment 16 back to Control Port 14 and then detected by the Data Process Device 12 (referenced in Steps 236 and 242 in FIG. 6 and referenced as Reaction Feedback 26 in FIG. 1). Under this example, if the Controlled Equipment 16 is not yet configured, the user is asked to first connect the RS232 cable to facilitate communication of the CNA with Controlled Equipment 16. The ACR process then begins with Request 20 (see FIG. 1) for an RS232 control code from Control Command Database 18.

### User Interface Configuration and Generation

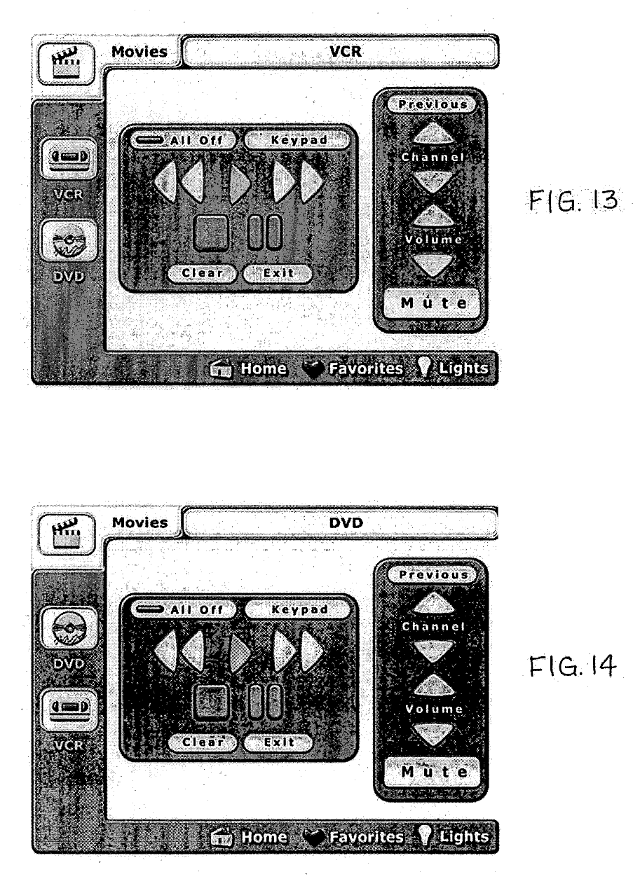

FIGS. 13, 14 and 15 are specific examples of a graphical user interface or control web page for Controlled Equipment 16, according to one embodiment of the disclosure. Once the ACR is complete and the CNA has acquired the other associated appropriate control codes for Controlled Equipment 16 in memory, the CNA will automatically generate a user interface based on the active control codes for that device. The user interface can be any of a variety of user interfaces known in the art, including graphical user interface (GUI) or internet or web pages that are then presented to the TCP/IP network based on HTTP requests.

The user interface will contain all of the information available to control the device, for example if a VCR has commands for Play, Stop, Pause, Rewind and Fast Forward, these commands will be “assigned” to buttons on the appropriate user interface template. Once a button has been assigned a valid control code, it becomes visible and will be part of the user interface for that device.

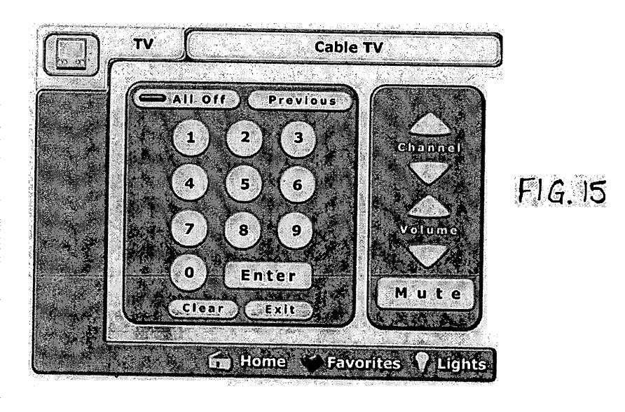

An example for a VCR is shown in FIG. 13. An example for a DVD is shown in FIG. 14 and an example for a cable television is shown in FIG. 15. The layout of the user interface in FIGS. 13-15 are for example only. The user interface is user-customizable, in that the look and feel of the “skin” can be modified according to user or manufacturer preference, or depending upon the specific mechanism used to display the user interface.

While certain of the preferred embodiments of the present invention have been described and specifically exemplified above, it is not intended that the invention be limited to such embodiments. Various modifications may be made thereto without departing from the scope and spirit of the present invention, as set forth in the following claims.

We claim:

1. A method for controlling an electronic device using a data processing device, comprising:
retrieving a control code from a database, wherein the control code corresponds to an electronic device;
using the control code to configure a communication port, wherein the communication port is capable of sending a control signal to the electronic device;
sending the control signal to the electronic device;
detecting the presence or absence of a reaction feedback to the control signal; and
retrieving a set of control codes from the database for the electronic device based on the presence of the reaction feedback.

2. The method of claim 1, further comprising generating a user interface based on the set of control codes.

3. The method of claim 2, wherein the user interface is capable of controlling the electronic device.

4. The method of claim 3, further comprising controlling the electronic device using the user interface.

5. The method claim 3, wherein the user interface is a control web page.

6. The method of claim 3, wherein the user interface is user-customizable.

7. A system for controlling electronic devices, comprising:
a data processing device with a communication port; wherein the data processing device is capable of:
retrieving a control code from a database, wherein the control code corresponds to an electronic device;
using the control code to configure the communication port, wherein the communication port is capable of sending a control signal to the electronic device;
sending the control signal to the electronic device;
detecting the presence or absence of a reaction feedback to the control signal; and
retrieving a set of control codes from the database for the electronic device based on the presence of the reaction feedback.

8. The system of claim 7, wherein the data processing device is further capable of generating a user interface based on the set of control codes.

9. The system of claim 7, wherein the data processing device is further capable of controlling the electronic device using the set of control codes.

10. The system of claim 8, wherein the user interface is a control web page.

11. The system of claim 8, wherein the user interface is user customizable.

12. The system of claim 7, further comprising a database, wherein the database includes the control code corresponding to the electronic device.

13. An electrical chip, comprising:
a data processing device, wherein the data processing device is electrically coupled to a communication port, wherein the communication port is capable of sending or receiving information from an exterior source; and
a database containing a control code, wherein the control code corresponds to an electronic device.

14. The electrical chip of claim 13, wherein the data processing device is capable of communicating with a network.

15. The electrical chip of claim 13, wherein the database further comprises a second control code corresponding to the electronic device, wherein the second control code is associated with the first control code.

16. The electrical chip of claim 13, further comprising feedback sense circuitry.

17. A computer-readable storage medium containing computer executable code for instructing a data processing device to perform the steps of:
retrieving a control code from a database, wherein the control code corresponds to an electronic device;
using the control code to configure the communication port, wherein the communication port is capable of sending a control signal to the electronic device;
prompting the communication port to send the control signal to the electronic device; and
detecting the presence or absence of a reaction feedback to the control signal; and
retrieving a set of control codes from the database for the electronic device based on the presence of the reaction feedback.

18. The computer-readable storage medium of claim 17, wherein the set of control codes is used to generate a user interface.

19. The computer-readable storage medium of claim 18, wherein the set of control codes is capable of controlling the electronic device.

20. The computer-readable storage medium of claim 18, wherein the user interface is a control web page.
